(19) United States
(12) Patent Application Publication
(10) Pub. No.: US 2009/0310672 A1
(43) Pub. Date: Dec. 17, 2009

(54) Method and System for Rate Control in a Video Encoder

(75) Inventors: Naveen Gandham Rao, North Attleboro, MA (US); Francisco Javier Roncero, Madrid (ES); Alberto David Duenas, Mountain View, CA (US)

Correspondence Address: Partridge Snow & Hahn, LLP, 180 South Main St., Providence, RI, 02903, US

(73) Assignee: W&W Communications, Inc., Sunnyvale, CA (US)

(21) Appl. No.: 12/139,188

(22) Filed: Jun. 13, 2008

(51) Int. Cl. H04N 7/26

(52) U.S. Cl. 375/240.03; 375/E07.14

(57) ABSTRACT

A method and system for a rate control block that adjusts the Quantization Parameter (QP) for a frame or macroblock based on the number of bits already used in encoding the frame or macroblock is disclosed. In an embodiment of the invention, the QP for a macroblock is adjusted dynamically against the QP for a frame as a function of the buffer occupancy. In another embodiment of the invention, a range of allowable QPs are defined based on the buffer occupancy. Embodiments of the invention are applicable to H.264 high-definition video conferencing.

### FIELD OF THE INVENTION

The invention relates generally to the field of video encoding, and more particularly to rate control for video encoders.

### BACKGROUND OF THE INVENTION

The International Telecommunication Union and the International Standards Organization developed a set of standards for low bit rate video compression. The standards are commonly referred to as H.264, MPEG-4, Part 10 or AVC (Advanced Video Coding.) The goal of H.264 and similar standards is to provide a common set of standards for video compression that can be applicable to a number of video applications and can allow various encoders and decoders to function together. Because H.264 is capable of producing low bit rates it is used for high-definition (HD) video applications.

Videos are made up of a series of frames, where each frame represents a single point in time of a particular scene or moving image. The frames are made up of pixels. The number of pixels in a frame determines the resolution of that frame. Each frame is further sub-divided into macroblocks, representing a small portion of a single frame. A typical 1080i HD video will have approximately 30 frames per second and each frame will have 1920×1080 pixels. A macroblock is typically a block of 16×16 pixels. The large number of pixels in an HD-video requires a considerably larger number of bits than standard videos.

Video compression aims to reduce the number of bits in a video, without significantly reducing the resolution or quality of the image. A common method of reducing the bit rate is by prediction, where redundant information is intelligently reduces. Video encoders and video compression algorithms will make predictions as to how the frame looks based on the redundancies that exist within a frame, spatial redundancy, and the redundancies that exist between a series of frames, temporal redundancy. For example, a scene that remains constant over time will be redundant in the temporal domain. However, once the scene changes, the amount of redundancy will be minimal, resulting in a spike in the bit requirements.

Another method of reducing the bit rate is by discarding information through quantization. Quantization maps a range of values to a single value. Once a frame or macroblock is represented in the frequency domain, using one of the transform functions known in the art, such as Discrete Cosine Transformation or Integer Transformation, quantization will be performed to increase the quantization step and therefore have fewer discrete values possible to represent the entire range. The idea being that it is not necessary to have the full number of discrete steps in order to maintain a high quality image. The set of distinct values used in quantization is based on a step size, or quantization parameter (QP). When the step size is increased more values are encompassed in an individual step. Greater step sizes result in a reduced number of bits and reduced image quality.

Videos that need to be sent over a network, such as the Internet, to an endpoint, must meet additional requirements regarding the bit rate. Given the stochastic nature of the Internet, all of the information pertaining to an image does not reach the endpoint at the same time. Therefore, buffers are needed to temporarily store and collect the bits before sending the bit stream and corresponding image to the endpoint. The size of the buffer determines how many bits the buffer is capable of storing and how much time is required before the bit stream is finally sent to the endpoint. The size of the buffer effects the latency of the video encoding system. To avoid excessive delays in sending a video over the Internet, the buffer cannot be set too large. However, the buffer must be set large enough to accommodate any spikes in the bit rate.

The bit stream must meet the requirements of the buffer, or information will be lost. The bit stream is generally controlled by a rate control block. Rate control aims to send as much bit information as possible, without exceeding the network bit-rate and buffer size and while maintaining the image quality.

HD Video Conferencing is an application of the H.264 video compression standard that presents unique challenges to rate control. The most important constraint is the real-time nature of video conferencing. The parties must be able to communicate with one another in real-time. Any delays in the communication over 0.5 seconds will make the video unwatchable and a video conferencing unit unusable. Therefore, given the inherent latency of the Internet, rate control and encoding times must be done efficiently and be kept at an absolute minimum.

Rate control methods in the prior art do not address the issue of low latency and maintaining a smaller buffer. Also, the prior art does not efficiently and quickly address the issue of spikes in the bit rate, especially in low latency environments. Therefore in a scene change or a highly complex video, the bit rate will be much higher and may not fit within the constraints of a buffer. Prior inventions also focus on applying rate control methods based on whether the image represents a scene change. The entire frame is analyzed by comparing each macroblock temporally and spatially. This requires buffering an entire frame and thus incurring more than a frame's worth of delay in the encoding process, which is too much for real-time applications.

### SUMMARY OF THE INVENTION

It is an object of the invention to develop a method and system for rate control, applicable to H.264 standards. It is a further object of the invention to develop a method and system for rate control for single-pass, real time, high-definition video applications that can maintain high image quality, with low processing times. It is a further object of the invention to develop a method and system for rate control that can operate independently of the complexity of the current frame or macroblock as it compares to previous frames and macroblocks. It is a further object of the invention to develop a method and system for rate control that can be used on both high complexity and low complexity frames.

Exemplary embodiments of the invention are concerned with a method and system for a rate control block that adjusts the Quantization Parameter (QP) for a frame or macroblock based on the number of bits already used in encoding the frame or macroblock. In another embodiment of the invention, the QP for a macroblock is based on the occupancy of a buffer. In another embodiment of the invention, a range of allowable QPs are defined based on the occupancy of a buffer.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a flowchart diagram of an embodiment of the present invention illustrating a method for setting a quantization parameter.

FIG. 2 is a flowchart diagram of an embodiment of the present invention illustrating a method for setting a quantization parameter.

FIG. 3 is an illustration of right and left bit shifting.

FIG. 4a is a flowchart diagram of an embodiment of the present invention illustrating a method for setting a range of quantization parameter values.

FIG. 4b is a flowchart diagram of an embodiment of the present invention illustrating an optimized method for setting a range of quantization parameter values.

FIG. 5 is a diagram illustrating an example of a video conferencing session.

FIG. 6 is a block diagram of an embodiment of the present invention illustrating a system for a video.

### DETAILED DESCRIPTION

A method and system for rate control in a video encoder is described. In the following description specific details are set forth, such as device types, system configurations, protocols, applications, methods, etc., in order to provide a thorough understanding of the present invention. However, persons having ordinary skill in the relevant arts will appreciate that these specific details may not be needed to practice the present invention.

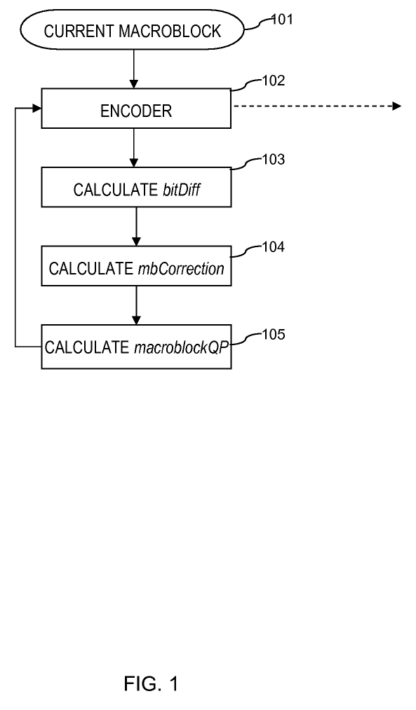

FIG. 1 is a flowchart illustrating an embodiment of the present invention. It depicts a method for offsetting the quantization parameter (QP) of a frame at each macroblock, based on the number of bits already used to encode the frame. The method includes the steps of starting with a current macroblock to be input to an encoder 101, encoding the current macroblock and outputting the encoded bit stream of the current macroblock 102, calculating the bit difference, bitDiff 103, calculating the correction factor, mbCorrection 104, using mbCorrection to calculate the QP based on the current macroblock, macroblockQP, 105 and sending the macroblockQP back to the encoder step 102 where it will be used to encode the next macroblock.

Step 101 begins at a current macroblock. Macroblocks in a frame of n macroblocks, are encoded one at a time, beginning at the first macroblock in a frame. At the point of the current macroblock, all previous macroblocks in the frame have already been encoded. At step 102, encoding will be performed on the macroblock. The encoding includes removing any redundancies in the macroblock and transforming the macroblock to a frequency domain. Encoding is performed by using parameters that are either defined at this step, input to this step or are input by a user. First, there is a quantization parameter for the entire frame, frameQP. Second, there is a number of bits targeted to be used for encoding an entire frame, targetFrameBits. This value is based on the constraints of the system on to which the method is applied. For example, in HD video conferencing, the targetFrameBits may be reduced so that video processing times and sending times are reduced. There is also the macroblockQP, which is based on the frameQP and is adjusted according to the macroblocks that have already been encoded within the current frame.

The targetFrameBits, bit information and bit requirements of the current macroblock are sent to step 103 to calculate the bitDiff. The bitDiff is the difference between the number of bits actually used in encoding a frame through the current macroblock and the number of bits targeted to be used in encoding a frame through the current macroblock, targetCurrentBits. The formula for calculating the number of bits targeted to be used up through the current macroblock is:

$$targetCurrentBits = \frac{currentMB}{n} * targetFrameBits$$

where n is the total number of macroblocks in the frame and currentMB is the number of encoded macroblocks in the frame. The bitDiff is represented by the formula:

Bitdiff=currentBits−targetCurrentBits,

where currentBits is obtained from the encoding step 102 and represents the number of bits that have already been used to encode the frame from the first macroblock to the current macroblock.

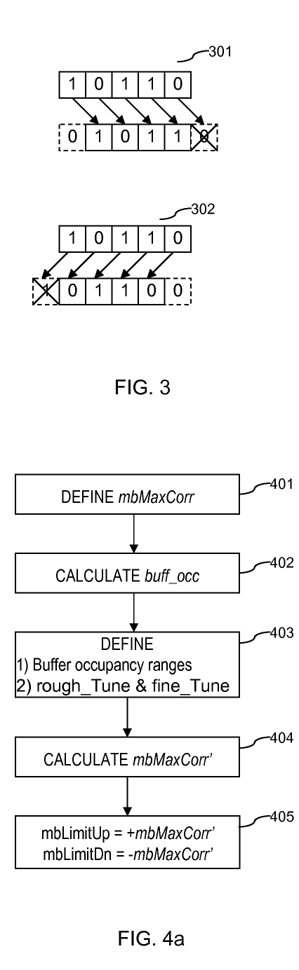

In step 104, a right shift is applied to the bitDiff to obtain the mbCorrection. FIG. 3 is an illustration of a right shift. It is appreciated that bit shifting is a technique used by those skilled in the art to perform arithmetic operations, such as multiplication and division, which is considerably faster than standard arithmetic calculations. FIG. 3 301, depicts a 1 bit right shift, where each bit is shifted to the right by one position, and a 0 is added to the vacated bit on the left. The formula for shifting the bits of the bitDiff is:

mbCorrection=bitDiff>>x,

where ‘>>’ is the operand for right shift and x is the number of positions to shift the bits. The value x is defined by the user and is based on the requirements of the system and how much degradation of the image will be tolerated.

In another embodiment of the invention, the formula for mbCorrection is:

mbCorrection=(bitDiff>>x)².

This formula is optimized for H.264 applications, where the quantization parameter does not map linearly to the bits. In an embodiment of the present invention, an optimized value for x is defined in the following formula:

x=mbShift+9.

The parameter mbShift is a variable shift parameter and the number 9 represents a fine adjustment on the shift value.

In step 105, the mbCorrection is added to the frameQP to fine tune the image quality and number of bits and obtain a macroblockQP. The resulting macroblockQP is returned to the encoding step 102 and used to encode the next macroblock and output the compressed bit stream.

If the current macroblock is the first macroblock within a frame then it is not necessary to offset the frameQP. No bits will have been used at the first macroblock. The mbCorrection will be equal to zero and the macroblockQP will be equal to the frameQP.

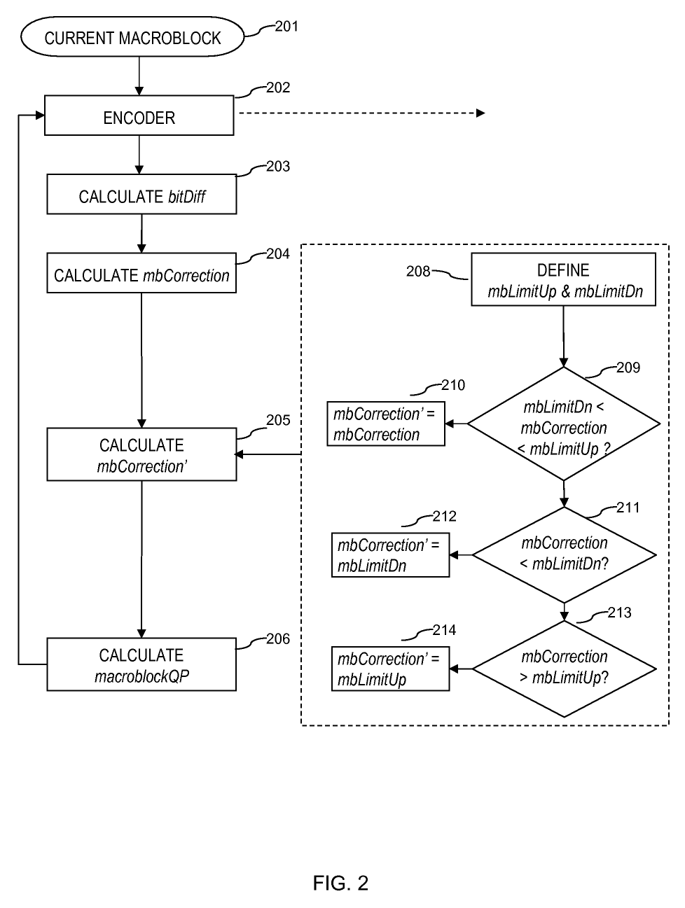

FIG. 2 is flowchart illustrating another embodiment of the present invention. It is an alternate method for offsetting the frameQP to obtain a macroblockQP, where the correction factor is limited. The method follows steps 101-104 of FIG. 1, that is, starting with a current macroblock to be input to an encoder 201, encoding the current macroblock 202, calculating the bit difference, bitDiff 203, and calculating the correction factor, mbCorrection 204. At this point an adjusted mbCorrection is calculated, mbCorrection', 205 and mbCorrection' is added to the frameQP to obtain the macroblockQP 206, which is returned to the encoder to complete encoding the next macroblock.

Calculating mbCorrection' includes the step of defining an upper limit, mbLimitUp, and a lower limit, mbLimitDn, for the correction factors 208. mbLimitUp represents the maximum allowable correction factor that can be applied to the frameQP, or the maximum degradation allowed to the image quality. mbLimitDn represents the minimum allowable correction factor that can be applied to the frameQP. These values may be user-defined, variable and/or based on the requirements of the system and the requirements of the image quality. mbLimitUp and mbLimitDn may be the same magnitude. It is appreciated that by limiting the magnitude of mbCorrection, the QPs of the n macroblocks within a single frame can be more consistent and thus produce a more homogeneous image. After defining the limits, mbCorrection is evaluated. If mbCorrection is between mbLimitUp and mbLimitDn 209, then mbCorrection' is equal to mbCorrection 210. If mbCorrection is less than mbLimitDn, 211,and therefore exceeds maximum allowable negative correction, then mbCorrection' is equal to mbLimitDn 212. If mbCorrection is greater than mbLimitUp 213, and therefore exceeds the maximum allowable positive correction, then mbCorrection' is equal to mbLimitUp 214.

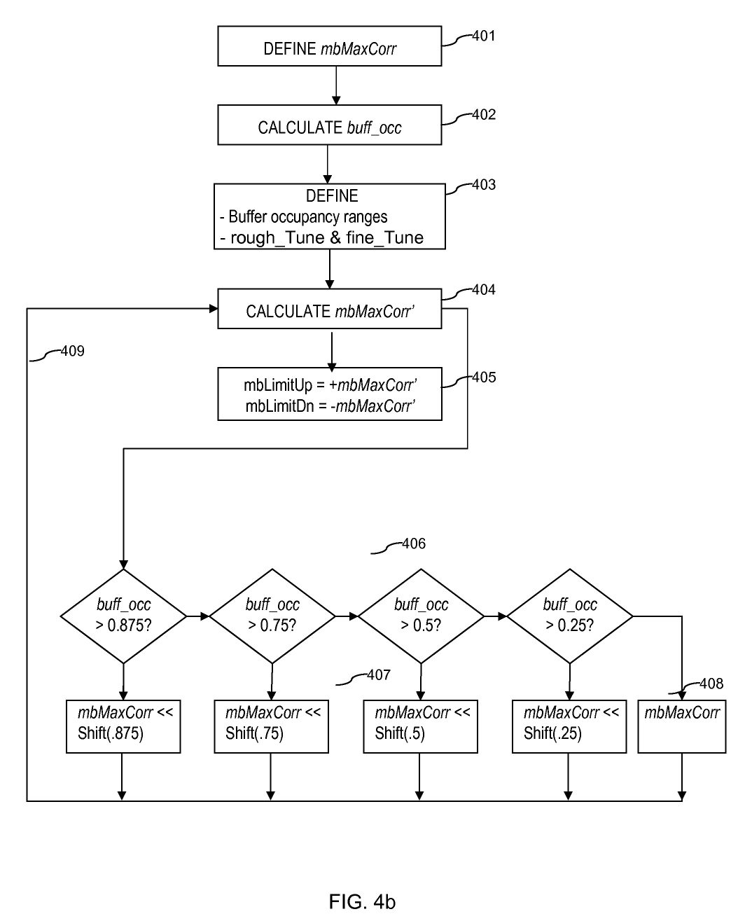

FIG. 4a illustrates another embodiment of the present invention. It is a method for setting a range of allowable values of the correction factor for a QP to be used for encoding, based on the current state of the system buffer. The method includes the steps of defining a maximum magnitude correction, mbMaxCorr, to the quantization parameter under nominal conditions 401, calculating the current occupancy of the buffer, buff_occ, 402, defining buffer occupancy ranges and corresponding shift parameters 403, calculating an adjusted maximum correction, mbMaxCorr', allowable to the quantization parameter, based on buff_occ and shifting parameters 404, and finally setting a lower and upper limit for the correction factor, mbLimitUp and mbLimitDn 405.

The maximum correction, mbMaxCorr, is defined by the user and is based on the constraints of the system to which the method is applied. It is appreciated that nominal conditions include situations where there is not a scene change, where the image is not highly complex or where there exists a minimal amount of redundancy.

The buffer occupancy, buff_occ, is equal to the number of bits currently in the buffer, divided by the total number of bits the buffer can accommodate. The size of the buffer is based on the constraints of the system. In a video conferencing application, or other real-time application, the buffer must be kept at a minimum. The buffer will reach capacity more quickly in these applications.

Based on the requirements of the system and application on to which the method of FIG. 4a is applied, a number of buffer occupancy ranges, or bins can be set. The user can dictate how much or how little degradation of the image is allowed based on how full the buffer is. If the buffer is nearly depleted, because of a highly complex image or a scene change, a larger amount of degradation may be tolerated. Some applications may allow for or be able to tolerate lower image qualities. The number of bins set depends on the system requirements and how precisely the QP needs to be adjusted based on the buffer occupancy.

In the present invention, a left bit shift, as illustrated in FIG. 3 302, is applied to mbMaxCorr, represented by the formula:

mbMaxCorr'=mbMaxCorr<<rough_Tune(buff_occ),

where ‘<<’ is the operand for a left shift and rough_Tune is a variable, user-defined parameter of the number of bits to shift mbMaxCorr and is a function of buff_occ. A rough_Tune value may be defined for each buffer occupancy range. It is appreciated that as the buffer reaches capacity, the QP may also increase, to reduce the size of the incoming bit stream and to ensure that the incoming bit stream does not exceed the size of the buffer.

In a further embodiment of the method of FIG. 4a, an additional fine tuning of mbMaxCorr' can be performed. This is represented by the formula:

mbMaxCorr'=(mbMaxCorr<<rough_Tune(buff_occ))+fine_Tune(buff_occ),

where fine_Tune is a variable, user-defined parameter that is a function of the buffer occupancy. A fine_Tune value may be defined for each buffer occupancy range and may be used to more precisely select the QP.

In Step 405, mbLimitUp and mbLimitDn are defined based on mbMaxCorr' and represented in the following formulas:

mbLimitUp=+mbMaxCorr' and

mbLimitDn=−mbMaxCorr'.

Once the values of mbLimitUp and mbLimitDn have been defined, they can be applied to methods for offsetting a QP, as depicted in FIG. 2. The values of mbLimitUp and mbLimitDn constitute a range of allowable values for the correction factor. It is appreciated that, based on the system requirements, steps 402-405 may be performed only to calculate one of mbLimitUp or mbLimitDn and the remaining parameter can be defined by mbMaxCorr. It is appreciated that the range of values for the correction factor can be applied to the frameQP to obtain a macroblockQP for a current macroblock, or can be applied to a QP for the video to obtain a frameQP.

FIG. 4b illustrates another embodiment of the present invention. It depicts an exemplary method for setting buffer occupancy ranges or bins. The optimal buffer occupancy ranges are defined in step 403 as: 1) buff_occ>0.875; 2) buff_occ>0.75; 3) buff_occ>0.5; 4) buff_occ>0.25; 5) all else. It is appreciated by those skilled in the art that these bins are optimal because they are efficient in terms of time and memory in terms of the arithmetic calculations. A rough_Tune value is defined for each of the occupancy ranges. Where the buffer is less than 25% full, it is not necessary to further degrade the picture, and mbMaxCorr is not adjusted 408. In applications where additional fine tuning is required, a fine_Tune value may be defined for each of the occupancy ranges. Once it is determined which buffer occupancy range the buffer falls in 406, mbMaxCorr is shifted accordingly 407. The result of the shifted mbMaxCorr (or mbMaxCorr, where buff_occ<0.25), is returned 409 to step 404 to set mbLimitUp and mbLimitDn.

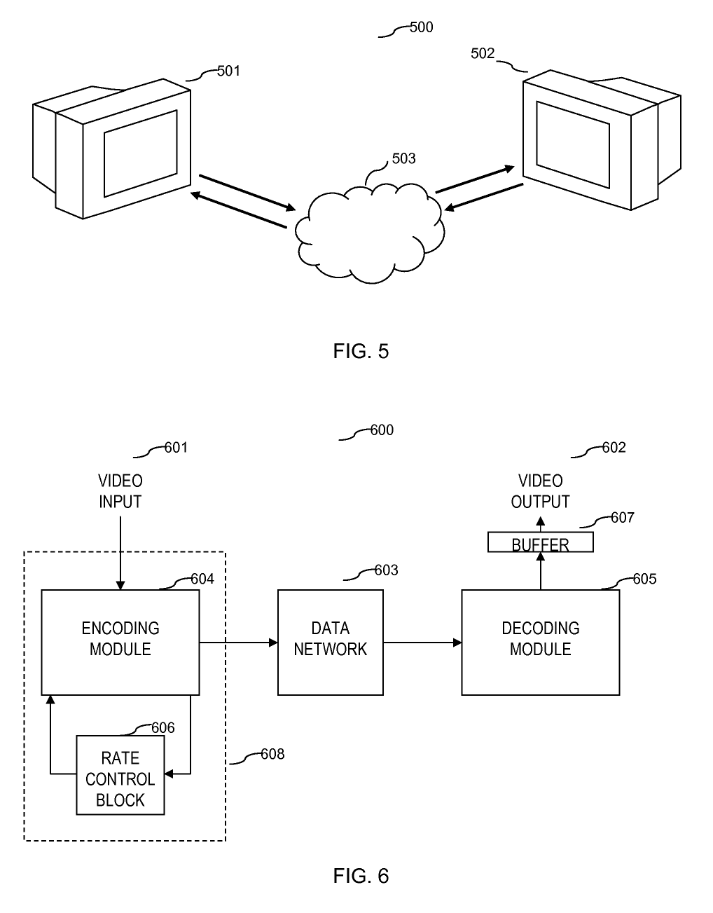

It is appreciated that the embodiments of the present invention as set forth are applicable to a video conferencing session, as depicted in FIG. 5. In FIG. 5, the video system 500 comprises a first terminal 501 at a first location and a second terminal 502 at a second location. The first and second terminals 501, 502 must be capable of displaying videos. The first and second terminals 501, 502 must also be able to communicate with, send information to and receive information from a network 503, such as the Internet. A person or persons located at the first terminal 501 and another person or persons located at the second terminal 502 communicate with one another. A communication from the first terminal 501, including the image and accompanying sound are sent to the second terminal 502 through the network 503, and vice versa. A video conferencing system may include more than two terminals. The communications sent between the terminals may be in high-definition. It is further appreciated that the person or persons at the terminals must be able to communicate in real time for effective communication.

FIG. 6 depicts a block diagram of a system of an embodiment of the present invention. The system 600 in FIG. 6 comprises a video input 601, a video output 602, data network 603, an encoding module 604, a decoding module 605, a rate control block 606, a buffer 607 and alternatively an encoding unit 608. The video input 601 is a raw, uncompressed video, as received from a video source, such as the first terminal 501 in FIG. 5. The video input is comprised of a series of frames. It is appreciated that the video may be standard definition or high-definition.

The video input 601 enters the encoding module 604. The encoding module encodes the video according to the H.264 encoding standard. It is appreciated that the encoding module and embodiments of the present invention may be applicable to standards similar to the H.264 encoding standard. As part of the encoding process, the encoding module uses quantization parameters (QP) to quantize the bits and reduce the size of the bit stream. During the encoding process, information from a frame or macroblock within the video input 501 is sent from the encoding module 604 to the rate control block 606 to obtain the optimal QP for the frame or macroblock. The rate control block 606, sends the optimal QP to the encoding module to complete the encoding of the frame or macroblock. The rate control block 606 can set the QP based on the number of bits already used to encode the current frame or current video. The rate control block 606 can also set the QP based on the current state of the buffer 607 in the system. The rate control block 606 uses user-defined or calculated limits to set the QP.

It is appreciated that in embodiments of the invention, the rate control block 606 can be incorporated into the encoding module 604, to form a complete encoding unit 608. The encoding block 608 performs all the same functions of the encoding module 604 and the rate control block 606 and outputs the same encoded bit stream of the video input.

The encoding module 604 outputs a bit stream, which is the original video input 601, compressed. The compressed, encoded bit stream of the video input 601 is sent to a data network 603, such as the Internet. The data network 603 receives the bit stream and sends it through the network and on to a decoding module 605. The decoding module 605 decodes the compressed, encoded bit stream according to the encoding module 604 and the H.264 standard as applied in the encoding module 604.

The decoded bit stream is sent on to a buffer 607. The buffer compensates for any irregularities in the flow of the bit stream through the data network 603 by holding and storing the bit stream before sending it on. The size of the buffer and the amount of time the bit stream is held is set to the requirements of the user application. It is appreciated that as hardware requirements dictate, the buffer 607 may be located before the decoding module 605, according to the requirements of the user application. Once the bit stream has been decoded by the decoding module 605, and gone through a buffer 607, a video output 602 is sent. In a video-conferencing session 500, the video output is displayed on a terminal 502.

The above description is included to illustrate embodiments of the present invention and is not meant to limit the scope of the invention. The scope of the invention is to be limited only by the claims set forth below. From the above discussion, many variations will be apparent to one skilled in the art that are encompassed by the scope and spirit of the following claims.

What is claimed is:

1. A method for encoding a macroblock within a frame of a video, comprising:
defining a first quantization parameter for the frame;
determining a first correction factor based on the number of bits already required to encode the frame up to said macroblock;
setting a positive correction limit and a negative correction limit based on the percentage occupancy of a buffer;
determining a final correction factor based on the first correction factor, a positive correction limit and a negative correction limit; and
applying the final correction factor to the first quantization parameter for the frame to obtain a second quantization parameter for said macroblock, wherein said second quantization parameter is used to encode said macroblock.

2. The method of claim 1, wherein if said macroblock is the first macroblock within said frame, the second quantization parameter is equal to the first quantization parameter.

3. The method of claim 1, wherein determining the first correction factor comprises:
setting a first target number of bits to be used for encoding said frame;
calculating a second target number of bits to have been used at the point of said macroblock;
determining an actual number of bits, which represents the number of bits actually used at the point of said macroblock;
determining a bit difference, wherein the bit difference is the difference between the second target number of bits and the actual number of bits;
performing a right shift on the bit difference, by a first shift value, wherein the first shift value is a user-defined, variable parameter; and
squaring the right shifted bit difference to obtain the first correction factor.

4. The method of claim 1, wherein setting the positive correction factor and the negative correction factor comprises:
setting one or more buffer occupancy ranges;
defining one or more rough-tune values, wherein each of the one or more rough-tune values corresponds to one of the buffer occupancy ranges;
defining one or more fine-tune values, wherein each of the one or more fine-tune values corresponds to one of the buffer occupancy ranges;
setting a maximum correction, wherein the maximum correction is the maximum allowable delta for the first quantization parameter under nominal conditions;
determining the current buffer occupancy and corresponding current buffer occupancy range;
adjusting the maximum correction by performing a left shift by the rough-tune value corresponding to the current buffer occupancy range and adding the fine-tune value corresponding to the current buffer occupancy range;
setting the positive correction limit to equal the adjusted maximum correction; and
setting the negative correction limit to equal the negative value of the adjusted maximum correction.

5. The method of claim 1, wherein the magnitude of the negative correction factor cannot be greater than the magnitude of a maximum correction factor, wherein the maximum correction factor is user-defined and represents the maximum correction allowed to the first quantization parameter under nominal video conditions.

6. The method of claim 1, wherein the magnitude of the positive correction factor cannot be greater than the magnitude of a maximum correction factor, wherein the maximum correction factor is user-defined and represents the maximum correction allowed to the first quantization parameter under nominal video conditions.

7. The method of claim 1, wherein determining the final correction factor comprises:
setting the final correction factor to equal the first correction factor if the first correction factor is greater than the negative correction limit and less than the positive correction limit;
setting the final correction factor to equal the positive correction limit if the first correction factor is greater than the positive correction limit; and
setting the final correction factor to equal the negative correction limit if the first correction factor is less than the negative correction limit.

8. The method of claim 1, wherein the positive correction limit is defined for each of the following buffer occupancy ranges: 0-25% buffer occupancy, 25%-50% buffer occupancy, 50%-75% buffer occupancy, 75%-87.5% buffer occupancy and 87.5%-100% buffer occupancy.

9. The method of claim 1, wherein the negative correction limit is defined for each of the following buffer occupancy ranges: 0-25% buffer occupancy, 25%-50% buffer occupancy, 50%-75% buffer occupancy, 75%-87.5% buffer occupancy and 87.5%-100% buffer occupancy.

10. The method of claim 1, wherein the size of the buffer is user-defined and can be adjusted.

11. The method of claim 1, wherein the video is encoded consistent with the H.264 encoding standard.

12. A method for determining a range of allowable quantization parameter values for encoding a portion of a video comprised of frames and macroblocks, comprising:
defining a first quantization parameter for the video;
defining the size of a buffer for a video output unit;
setting an initial maximum correction, wherein the initial maximum correction is the maximum allowable delta for the first quantization parameter under nominal conditions;
setting a rough-tune value and a fine-tune value based on the current occupancy of the buffer.
setting a final maximum correction by performing a left shift on the initial maximum correction by the rough-tune value and adding the shifted initial maximum correction to the fine-tune value;
setting the range of allowable quantization parameter values to be from the first quantization parameter minus the final maximum correction to the first quantization parameter plus the final maximum correction.

13. The method of claim 12, wherein the video is encoded consistent with the H.264 encoding standard.

14. A system for sending a video to an output source, comprising:
a video input source supplying said video, wherein the video comprises frames and macroblocks;
an encoder unit capable of receiving frames, performing one or more encoding operations on a macroblock within a frame, receiving a quantization parameter for the macroblock, outputting bit requirements of the macroblock, and outputting a bit stream for the macroblock and frame;
a rate control unit capable of receiving bit requirements of said macroblock, determining a second quantization parameter, and outputting said second
quantization parameter;
a data network, capable of receiving and sending the bit stream;
a decoder unit, located after the data network and capable of receiving, decoding and outputting the bit stream;
a buffer, located after the date network, and capable of receiving, sending and storing a defined number of bits; and
a video output unit, for displaying the video.

15. The system of claim 14, wherein the rate control unit determines the second quantization parameter based on the number of bits already used in encoding the frame, the current occupancy of the buffer and the quantization parameter of the frame.

16. The system of claim 14, wherein the rate control unit is further capable of setting a range of allowable quantization parameters for the current macroblock.

17. The system of claim 14, wherein the encoder is consistent with the H.264 encoding standard.

18. The system of claim 14, wherein the system is a video conferencing system.

19. The system of claim 14, wherein the number of bits the buffer can store is user-defined.
